(19) United States
(12) Patent Application Publication
(10) Pub. No.: US 2026/0170890 A1
(43) Pub. Date: Jun. 18, 2026

(54) RECORDING METHOD, RECORDING APPARATUS, AND ELECTRONIC CONTROL UNIT

(71) Applicant: SUBARU CORPORATION, Tokyo (JP)

(72) Inventor: Yuta OSHIKUBO, Tokyo (JP)

(73) Assignee: SUBARU CORPORATION, Tokyo (JP)

(21) Appl. No.: 19/404,196

(22) Filed: Dec. 1, 2025

(30) Foreign Application Priority Data
Dec. 12, 2024 (JP) 2024-217210

(51) Int. Cl. G07C 5/10; G07C 5/08

(52) U.S. Cl. CPC G07C 5/10; G07C 5/0816

(57) ABSTRACT

A recording method is executed by a computer. In the recording method, the computer is configured to record a flag to be used in determination of a replacement history of an electronic control unit configured to be mounted on a vehicle. The recording method includes detecting, by the computer, an operation executed by the electronic control unit at the time of factory shipment of the vehicle, and recording, by the computer, an unreplaced flag indicating that the electronic control unit is not replaced in a memory included in the electronic control unit when the operation is detected.

### CROSS-REFERENCE TO RELATED APPLICATION

This present application claims priority from Japanese Patent Application No. 2024-217210 filed on Dec. 12, 2024, the entire contents of which are hereby incorporated by reference.

### BACKGROUND

The disclosure relates to a recording method, a recording apparatus, and an electronic control unit.

A technology for grasping a replacement history of an electronic control unit mountable on a vehicle has been known.

For example, in Japanese Unexamined Patent Application Publication (JP-A) No. 2000-185606, an in-vehicle electronic control unit that stores vehicle specific information in a non-volatile memory is disclosed. This in-vehicle electronic control unit has a configuration that newly writes, when an electronic control unit is replaced, vehicle specific information read out from an electronic control unit before replacement into a non-volatile memory, and a configuration that writes a history of the replacement of the electronic control unit into the same non-volatile memory following the writing of the vehicle specific information.

### SUMMARY

A recording method according to one embodiment of the disclosure is a recording method of a flag and is executed by a computer. The flag is configured to be used in determination of a replacement history of an electronic control unit configured to be mounted on a vehicle. The recording method includes detecting, by the computer, an operation executed by the electronic control unit at the time of factory shipment of the vehicle, and recording, by the computer, an unreplaced flag indicating that the electronic control unit is not replaced in a memory included in the electronic control unit when the operation is detected.

A recording apparatus according to one embodiment of the disclosure is configured to record a flag. The flag is configured to be used in determination of a replacement history of an electronic control unit configured to be mounted on a vehicle. The recording apparatus includes one or more processors, and one or more memories communicably coupled to the one or more processors. The one or more processors are configured to detect an operation executed by the electronic control unit at the time of the factory shipment of the vehicle. The one or more processors are configured to record an unreplaced flag indicating that the electronic control unit is not replaced in a memory included in the electronic control unit when the operation is detected.

An electronic control unit according to one embodiment of the disclosure is configured to be mounted on a vehicle. The electronic control unit includes a memory. Either a replaced flag indicating that the electronic control unit is replaced or an unreplaced flag indicating that the electronic control unit is not replaced is recorded in the memory. The replaced flag is configured to be rewritten to the unreplaced flag by being triggered by an operation executed by the electronic control unit at the time of factory shipment of the vehicle.

### BRIEF DESCRIPTION OF THE DRAWINGS

Features, advantages, and technical and industrial significance of exemplary

embodiments of the disclosure will be described below with reference to the accompanying drawings, in which like signs denote like elements, and wherein:

FIG. 1 is a schematic diagram illustrating a schematic configuration of a vehicle on which an electronic control unit according to one embodiment of the disclosure is mounted;

FIG. 2 is a block diagram illustrating a configuration example of the electronic control unit according to the embodiment;

FIG. 3 is a block diagram illustrating a configuration example of a recording apparatus according to the embodiment;

FIG. 4 is a diagram describing one example of the transition of a flag recorded in the electronic control unit according to the embodiment; and

FIG. 5 is a flowchart describing an operation example of the recording apparatus according to the embodiment.

### DETAILED DESCRIPTION

According to the technology as that disclosed in JP-A No. 2000-185606, when an

electronic control unit is replaced in a repair shop and the like, vehicle specific information read out from an electronic control unit before replacement is carried over, and a replacement history is written into an electronic control unit after replacement. However, regarding such technology, there is a fear that vehicle data such as a lifetime value may be falsified when the replacement history of the electronic control unit is written in the repair shop and the like. Therefore, cases where reliability against resistance to falsification of vehicle data decreases once the electronic control unit is replaced after the factory shipment of the vehicle are conceivable.

The disclosure provides a technology of securing reliability against resistance to falsification of vehicle data by suitably grasping a replacement history of an electronic control unit after factory shipment of a vehicle.

An embodiment of the disclosure is described in detail below with reference to the accompanying drawings. In the specification and the drawings, description of components having functional configurations that are substantially the same is omitted by denoting those components by the same characters. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale.

### 1. Vehicle

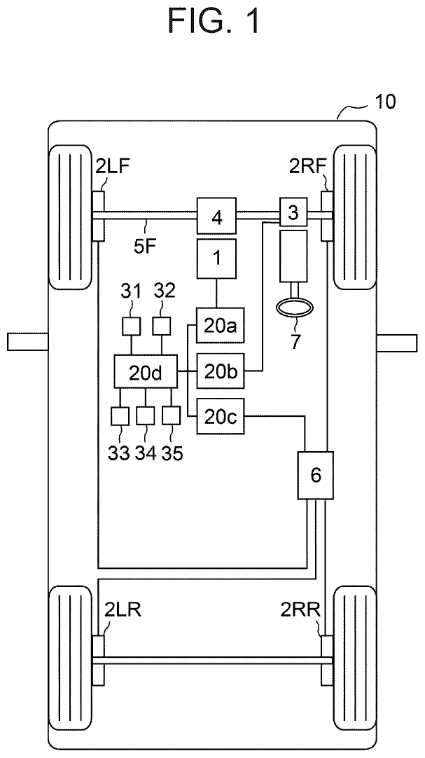

With reference to FIG. 1, a vehicle 10 is an automobile including an internal combustion engine such as a gasoline engine or a diesel engine as a driving power source 1, for example. However, the vehicle 10 is not limited to the above and may be an electric vehicle including a driving motor as the driving power source 1, for example. Examples of the electric vehicle include a battery electric vehicle (BEV), a hybrid electric vehicle (HEV), a plug-in hybrid electric vehicle (PHEV), and a fuel cell electric vehicle (FCEV).

The vehicle 10 is configured as a four-wheel automobile that transmits a driving torque output from the driving power source 1 to wheels. The combination of driving wheels and the driving method are not limited. The vehicle 10 may be a front-wheel-drive vehicle, a rear-wheel-drive vehicle, or a four-wheel-drive vehicle. When the vehicle 10 is configured as an electric vehicle, the vehicle 10 may be an electric vehicle that includes driving motors corresponding to respective wheels.

The vehicle 10 at least includes the driving power source 1 described above, brake apparatuses 2LF, 2RF, 2LR, 2RR, and an electrically-powered steering apparatus 3.

The driving power source 1 outputs a driving torque transmitted to a front-wheel driving shaft 5F via a transmission (not illustrated) and a differential mechanism 4. The driving of the driving power source 1 and the transmission is controlled by the electronic control unit 20 described later.

The brake apparatuses 2LF, 2RF, 2LR, 2RR apply a braking power to respective wheels. The brake apparatuses 2LF, 2RF, 2LR, 2RR may be hydraulic brake apparatuses, for example. In this case, the driving of a hydraulic unit 6 is controlled by the electronic control unit 20. As a result, hydraulic pressure supplied to each of the brake apparatuses 2LF, 2RF, 2LR, 2RR is regulated. When the vehicle 10 is configured as an electric vehicle, the brake apparatuses 2LF, 2RF, 2LR, 2RR may be used together with a regenerative brake by the driving motor serving as the driving power source 1.

The electrically-powered steering apparatus 3 is provided on the front-wheel driving shaft 5F. The electrically-powered steering apparatus 3 includes an electrically-powered motor (not illustrated) and a gear mechanism (not illustrated) and regulates the steering angle of front wheels by being controlled by the electronic control unit 20. The electronic control unit 20 controls the electrically-powered steering apparatus 3 based on the steering angle of a steering wheel 7 that is operated by a driver that drives the vehicle 10.

### 2. Electronic Control Unit

In an example illustrated in FIG. 1, the electronic control unit 20 includes an engine control unit 20a, a steering control unit 20b, a brake control unit 20c, and a vehicle control unit 20d. The engine control unit 20a is coupled to the internal combustion engine serving as the driving power source 1. The steering control unit 20b is coupled to the electrically-powered steering apparatus 3. The brake control unit 20c is coupled to the brake apparatuses 2LF, 2RF, 2LR, 2RR via the hydraulic unit 6. The vehicle control unit 20d is coupled to each control unit, that is, the engine control unit 20a, the steering control unit 20b, and the brake control unit 20c via an in-vehicle network such as a controller area network (CAN). The vehicle control unit 20d outputs control signals to the respective control units, that is, the engine control unit 20a, the steering control unit 20b, and the brake control unit 20c.

An accelerator sensor 31 that detects the operation amount of an accelerator pedal (not illustrated), for example, is coupled to the vehicle control unit 20d via an in-vehicle network such as a CAN. A brake sensor 32 that detects the operation amount of a brake pedal (not illustrated), for example, is coupled to the vehicle control unit 20d via an in-vehicle network such as a CAN. A vehicle speed sensor 33 that detects the vehicle speed of the vehicle 10, for example, is coupled to the vehicle control unit 20d via an in-vehicle network such as a CAN. An acceleration rate sensor 34 that detects the acceleration rate of the vehicle 10, for example, is coupled to the vehicle control unit 20d via an in-vehicle network such as a CAN. A steering angle sensor 35 that detects the steering angle of the steering wheel 7, for example, is coupled to the vehicle control unit 20d via an in-vehicle network such as a CAN.

The vehicle control unit 20d sets an operation target of the driving power source 1 based on input information from the accelerator sensor 31, the vehicle speed sensor 33, the acceleration rate sensor 34, and the like. Then, the vehicle control unit 20d generates a control signal in accordance with the set operation target and outputs the control signal to the engine control unit 20a. The vehicle control unit 20d sets an operation target of the electrically-powered steering apparatus 3 based on input information from the vehicle speed sensor 33, the acceleration rate sensor 34, the steering angle sensor 35, and the like. Then, the vehicle control unit 20d generates a control signal in accordance with the set operation target and outputs the control signal to the steering control unit 20b. The vehicle control unit 20d sets an operation target of the brake apparatus 2 based on input information from the brake sensor 32, the vehicle speed sensor 33, the acceleration rate sensor 34, and the like. Then, the vehicle control unit 20d generates a control signal in accordance with the set operation target and outputs the control signal to the brake control unit 20c. When the vehicle 10 is configured to be able to execute autonomous driving control, the steering control unit 20b can control the electrically-powered steering apparatus 3 based on the steering angle or the steering angular velocity set, as appropriate, with use of a well-known or any autonomous driving technology during the execution of the autonomous driving control.

However, the electronic control unit 20 in the disclosure is not limited to the control unit described above, and any control unit for controlling the vehicle 10 can be employed. For example, when the vehicle 10 is configured as an electric vehicle, the electronic control unit 20 may further include a motor control unit (not illustrated) coupled to the driving motor serving as the driving power source 1 instead of the engine control unit 20a or in addition to the engine control unit 20a. In this case, the electronic control unit 20 may further include a battery control unit (not illustrated) coupled to a driving battery that can supply electricity to the driving motor serving as the driving power source 1. The electronic control unit 20 may further include a driving assistance control unit (not illustrated) that assists the driving of the vehicle 10 by the driver. In this case, the driving assistance control unit performs driving assistance control such as the detection of the inter-vehicular distance between the vehicle 10 and a leading vehicle based on image data from a camera that captures images of the outside of the vehicle (not illustrated) mounted on the vehicle 10 or distance data from a ranging sensor (not illustrated) such as light detection and ranging (LiDAR).

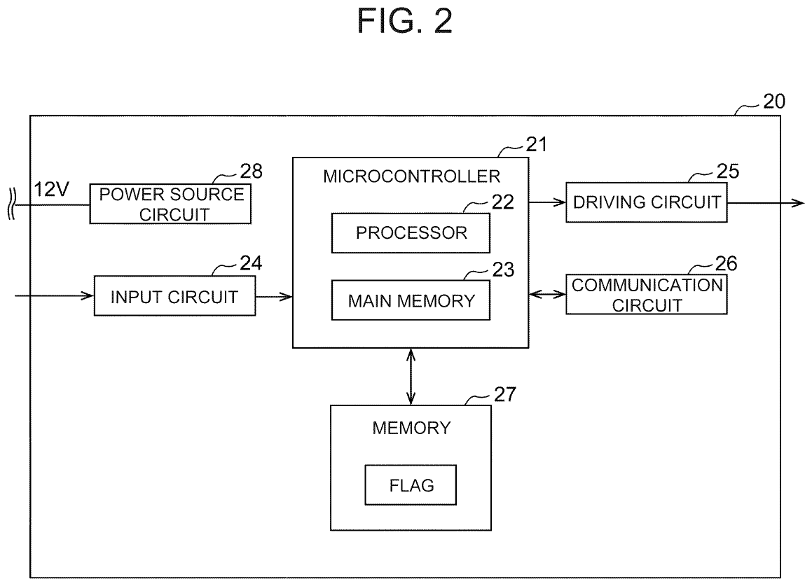

With reference to FIG. 2, the electronic control unit 20 includes a microcontroller 21. A processor 22 and a main memory 23 communicably coupled to the processor 22 are incorporated in the microcontroller 21. A program for operating the electronic control unit 20 is stored in the main memory 23, and the program is executed by the processor 22. For example, the electronic control unit 20 is configured to be able to operate by a plurality of sessions and is configured to be able to operate in each session and transition between sessions in accordance with the program stored in the main memory 23. The sessions are not limited but examples thereof include a session at the time of activation, a session at the time of reprogramming, a session at the time of operation of a service function, and a session at the time of completion inspection of the vehicle 10. The number of the processors 22 and the main memories 23 incorporated in the microcontroller 21 is any number.

The electronic control unit 20 includes an input circuit 24, a driving circuit 25, a communication circuit 26, a memory 27, and a power source circuit 28 other than the microcontroller 21. The input circuit 24 is a circuit for converting a signal received from various sensors and the like mounted on the vehicle 10 to a signal that can be input to the microcontroller 21. The driving circuit 25 is a circuit for generating a driving signal with respect to various in-vehicle equipment mounted on the vehicle 10 based on a signal output from the microcontroller 21. The communication circuit 26 is a circuit for converting a signal output from the microcontroller 21 to a communication signal for another control unit. The communication circuit 26 is a circuit for converting a communication signal received from another control unit to a signal that can be input to the microcontroller 21. The memory 27 is configured by a non-volatile memory such as a flash memory. Although details are described later, a flag to be used in the determination of the replacement history of the electronic control unit 20 is recorded in the memory 27. Various data and the like may be stored in the memory 27 besides the flag, but the various data and the like are stored in a storage region different from a storage region in which the flag is recorded. The power source circuit 28 is a circuit for supplying voltage from a low-voltage-system power source (for example, a 12-V power source) mounted on the vehicle 10 to the microcontroller 21, the input circuit 24, the driving circuit 25, the communication circuit 26, the memory 27, and the like. The electronic control unit 20 includes any connector terminal (not illustrated) for coupling a recording apparatus 40 described later, and any connector terminal (not illustrated) for coupling a function checker.

### 3. Recording Apparatus

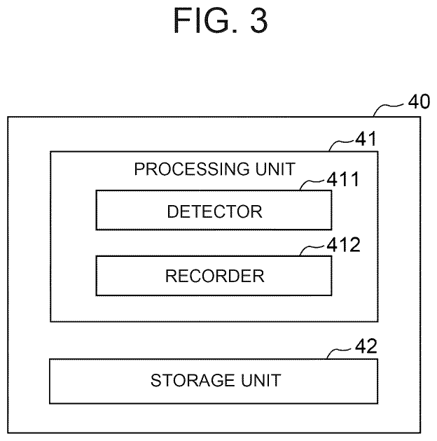

With reference to FIG. 3, the recording apparatus 40 according to the present embodiment is described in detail. The recording apparatus 40 may be configured as a terminal apparatus used by a worker in a completion inspection process of the vehicle 10 on a production line of the vehicle 10, for example, and is coupled to the electronic control unit 20 mounted on the vehicle 10.

### 3-1. Configuration Example of Recording Apparatus

In the recording apparatus 40, one or more processors such as a central processing unit (CPU) executes a computer program. As a result, the recording apparatus 40 serves as a computer for recording a flag to be used in the determination of the replacement history of the electronic control unit 20 mountable on the vehicle 10. The computer program is a computer program for causing the processor to execute an operation described later to be executed by the recording apparatus 40. The computer program executed by the processor may be recorded in a recording medium that serves as a storage unit 42 described later. The computer program executed by the processor may be recorded in a recording medium built in the recording apparatus 40 or any recording medium externally attachable to the recording apparatus 40.

The recording medium that records the computer program therein may be a magnetic medium such as a hard disk, a floppy disk, and a magnetic tape, an optical recording medium such as a CD-ROM, a DVD, and a Blu-ray (R), a magneto-optical medium such as a floptical disk, a storage element such as a RAM and a ROM, a flash memory such as a USB memory and an SSD, and other media that can store therein a program.

The recording apparatus 40 at least includes a processing unit 41 and the storage unit 42. The recording apparatus 40 includes a connector terminal (not illustrated) to be coupled to a connector terminal included in the electronic control unit 20 in the completion inspection process of the vehicle 10 on the production line of the vehicle 10, for example.

The processing unit 41 includes one or more processors such as a CPU and various peripheral parts. A part or the entirety of the processing unit 41 may be configured by parts that are updatable such as firmware or be a program module executed by a command from the CPU and the like, for example.

The storage unit 42 is configured by one or more storage elements such as a RAM or a ROM communicably coupled to the processing unit 41. However, the types or the number of the storage units 42 are not limited. The storage unit 42 stores therein a computer program executed by the processing unit 41, various parameters used in arithmetic processing, and information such as detection data and an arithmetic result.

### 3-2. Functional Configuration of Processing Unit

A functional configuration of the processing unit 41 of the recording apparatus 40 is described. The processing unit 41 includes a detector 411 and a recorder 412. Each of the detector 411 and the recorder 412 is a function realized by the execution of a computer program by one or more processors such as a CPU. However, a part or the entirety of each of the detector 411 and the recorder 412 may be configured with use of an analog circuit.

### Detector

The detector 411 detects an operation executed by the electronic control unit 20 at the time of factory shipment of the vehicle 10. The operation executed by the electronic control unit 20 at the time of factory shipment of the vehicle 10 may be hereinafter referred to as “an operation at the time of factory shipment”. The detector 411 may detect an operation in which the electronic control unit 20 transitions to a session at the time of completion inspection based on a completion inspection signal output from the function checker in the completion inspection process of the vehicle 10, for example, as an operation at the time of factory shipment. The detector 411 may detect normal end of the session at the time of completion inspection, for example, as an operation at the time of factory shipment. When the electronic control unit 20 receives a completion inspection signal from the function checker, the electronic control unit 20 transitions to the session at the time of completion inspection by the program stored in the main memory 23 illustrated in FIG. 2. However, the disclosure is not limited to the above. The electronic control unit 20 may be configured as below in terms of avoiding unintended operation. The electronic control unit 20 receives a completion inspection signal from the function checker and recognizes that a fuse for identifying that the vehicle 10 is on the production line is inserted into a predetermined section in a fuse box included in the vehicle 10. The electronic control unit 20 transitions to the session at the time of completion inspection in response to this recognition.

The completion inspection signal is any signal for inspecting whether the electronic control unit 20 mounted on the vehicle 10 functions normally. For example, a signal used in line-end air-purge control (a misfire diagnosis stop request) is exemplified as a completion inspection signal for the vehicle 10 including the internal combustion engine serving as the driving power source 1. However, the completion inspection signal in the disclosure is not limited to the above, and any signal used in the completion inspection of the vehicle 10 including an electric vehicle can be employed.

### Recorder

When the detector 411 detects the operation at the time of factory shipment, the recorder 412 records an unreplaced flag indicating that the electronic control unit 20 is not replaced on the memory 27 included in the electronic control unit 20 illustrated in FIG. 2.

Here, a replaced flag may be recorded in advance in a storage region within the memory 27 included in the electronic control unit 20. The storage region is not rewritable except when the operation at the time of factory shipment is detected by the detector 411. The replaced flag indicates that the electronic control unit 20 is replaced. In this case, once a replaced flag is recorded in the memory 27, the electronic control unit 20 is configured to permit the rewriting of the storage region in which the replaced flag is recorded in advance, generally when a completion inspection signal is received. The completion inspection signal is output from the function checker. In other words, once a replaced flag is recorded in the memory 27, the electronic control unit 20 is configured to prohibit the rewriting of the storage region in which the replaced flag is stored in advance except when a completion inspection signal is received. Therefore, the electronic control unit 20 permits the rewriting of the storage region in which the replaced flag is recorded in advance, generally when transition is made to the session at the time of completion inspection. The timing at which the replaced flag is recorded in advance may be a manufacturing process of the electronic control unit 20 itself, for example, but the disclosure is not limited thereto. The timing at which the replaced flag is recorded in advance may be any timing as long as the timing is before the completion inspection process of the vehicle 10.

When the operation at the time of factory shipment is detected by the detector 411, the recorder 412 records an unreplaced flag in the memory 27 included in the electronic control unit 20 by rewriting the replaced flag recorded in advance to an unreplaced flag. For example, when the operation at the time of factory shipment is detected by the detector 411, the recorder 412 records an unreplaced flag by rewriting the replaced flag recorded in advance in the storage region of which rewriting is permitted by the electronic control unit 20 to an unreplaced flag. The unreplaced flag recorded by the recorder 412 is recorded in a storage region that is within the memory 27 included in the electronic control unit 20 and is not rewritable, and this unreplaced flag is not erasable.

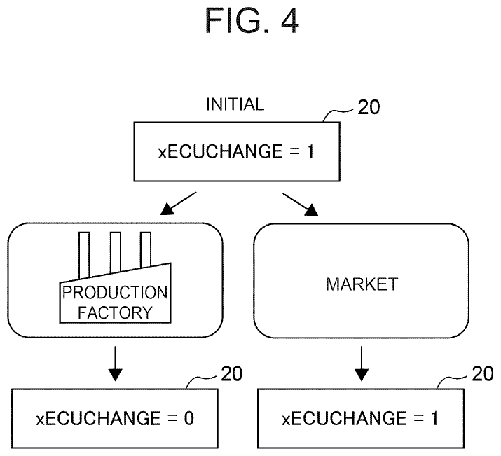

With reference to FIG. 4, the electronic control unit 20 in which a replaced flag (for example xECUCHANGE=1) is recorded in advance is mounted on the vehicle 10 in a production factory of the vehicle 10. After the electronic control unit 20 undergoes the operation at the time of factory shipment described above, an unreplaced flag (for example, xECUCHANGE=0) is recorded in the memory 27 of the electronic control unit 20. Meanwhile, when the electronic control unit 20 is put on the market without undergoing the operation at the time of factory shipment described above, the replaced flag recorded in advance (for example, xECUCHANGE=1) remains recorded in the memory 27 of the electronic control unit 20. In other words, in the memory 27 included in the electronic control unit 20, either a replaced flag (for example, xECUCHANGE=1) indicating that the electronic control unit 20 is replaced or an unreplaced flag (for example, xECUCHANGE=0) indicating that the electronic control unit 20 is not replaced is recorded. After the factory shipment of the vehicle 10, the worker accesses the memory 27 of the electronic control unit 20 mounted on the vehicle 10 with use of a well-known or any external diagnostic apparatus. The worker can suitably grasp the replacement history of the electronic control unit 20 by diagnosing the flag recorded in the memory 27. For example, when the electronic control unit 20 mounted on the vehicle 10 after the factory shipment of the vehicle 10 is replaced in a repair shop and the like, a replaced flag (for example, xECUCHANGE=1) is recorded in the electronic control unit 20 after replacement.

### 3-3. Operation Example of Recording Apparatus

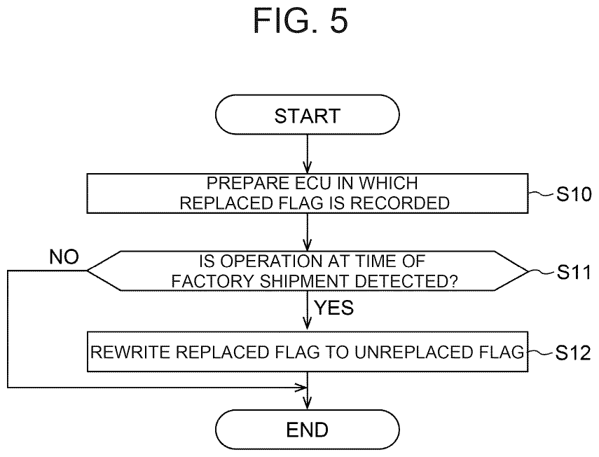

With reference to FIG. 5, an operation example of the recording apparatus 40 according to the present embodiment is described along a flowchart. This operation example is one example of a recording method according to the disclosure.

In Step S10, the electronic control unit 20 in which a replaced flag indicating that the electronic control unit 20 is replaced is recorded in the memory 27 in advance is prepared. In FIG. 5, an ECU is an abbreviation of an electronic control unit. The replaced flag is rewritable to an unreplaced flag by being triggered by the operation executed by the electronic control unit 20 at the time of factory shipment of the vehicle 10 in Step S11. The unreplaced flag indicates that the electronic control unit 20 is not replaced. Then, the process proceeds to Step S11.

In Step S11, the recorder 412 of the processing unit 41 determines whether an operation executed by the electronic control unit 20 at the time of factory shipment of the vehicle 10 (in other words, “the operation at the time of factory shipment” described above) is detected by the detector 411. When it is determined that the operation at the time of factory shipment is detected (Step S11: YES), the process proceeds to Step S12.

In Step S12, the recorder 412 of the processing unit 41 rewrites the replaced flag recorded in the electronic control unit 20 in advance in Step S10 to an unreplaced flag. Then, the process ends. As a result, an unreplaced flag indicating that the electronic control unit 20 is not replaced is recorded in the memory 27 included in the electronic control unit 20.

Meanwhile, when it is not determined that the operation at the time of factory shipment is detected (Step S11: NO), the process ends. As a result, the replaced flag indicating that the electronic control unit 20 is replaced remains recorded in the memory 27 included in the electronic control unit 20.

### 4. Conclusion

As described above, the processing unit 41 of the recording apparatus 40 according to the present embodiment records a flag to be used in the determination of the replacement history of the electronic control unit 20 in the electronic control unit 20 in which a replaced flag is recorded in the memory 27 in advance. The replaced flag indicates that the electronic control unit 20 is replaced. In other words, the processing unit 41 of the recording apparatus 40 detects an operation executed by the electronic control unit 20 at the time of factory shipment of the vehicle 10. In response to this detection, the processing unit 41 rewrites the replaced flag recorded in the memory 27 included in the electronic control unit 20 in advance to an unreplaced flag indicating that the electronic control unit 20 is not replaced.

According to this configuration, an unreplaced flag indicating that the electronic control unit 20 is not replaced is recorded in the memory 27 included in the electronic control unit 20 mounted on the vehicle 10 after the factory shipment. Meanwhile, a replaced flag indicating that the electronic control unit 20 is replaced is recorded in the memory 27 included in the electronic control unit 20 put on the market independently of the vehicle 10 after factory shipment. Therefore, it becomes possible to suitably grasp whether the electronic control unit 20 is replaced after the factory shipment of the vehicle 10 by diagnosing the flag recorded in the memory 27 included in the electronic control unit 20 mounted on the vehicle 10. Therefore, the replacement history of the electronic control unit 20 after the factory shipment of the vehicle 10 can be suitably grasped. As a result, the reliability against the resistance to falsification of the vehicle data can be secured.

According to the present embodiment, the flag to be used in the determination of the replacement history of the electronic control unit 20 is recorded by being triggered by the operation executed by the electronic control unit 20 at the time of factory shipment of the vehicle 10. Therefore, it becomes unnecessary to newly renovate a factory facility, for example, and the cost can be kept down in suitably grasping the replacement history of the electronic control unit 20.

The embodiment of the disclosure has been described in detail above with reference to the accompanying drawings, but the disclosure is not limited to examples above. It would be obvious that a person with an ordinary skill in the field of the art to which the disclosure pertains could conceive various changes or modifications within the scope of the technical idea described in the claims. It would be understood that those changes or modifications naturally fall within the technical scope of the disclosure as well. For example, a function and the like included in each configuration unit, each step, or the like can be rearranged so as to be logically consistent. A plurality of configuration units, steps, or the like can be combined into one or divided.

In the embodiment described above, a case where the replaced flag is recorded in the memory 27 in advance has been described, but the replaced flag is omittable. In other words, although an unreplaced flag is recorded in the memory 27 of the electronic control unit 20 by being triggered by the operation executed by the electronic control unit 20 at the time of factory shipment of the vehicle 10, at this time, a replaced flag is not necessarily recorded in the memory 27 of the electronic control unit 20 in advance as long as the unreplaced flag is distinguishable from other information recorded in the memory 27.

In the embodiment described above, it has been described that the recording apparatus 40 is coupled to the connector terminal included in the electronic control unit 20. However, the recording apparatus 40 may be configured as a program stored in the main memory 23 executed as a function of the electronic control unit 20.

The technology of the disclosure can also be realized as the electronic control unit 20 in the embodiment described above, the vehicle 10 on which the electronic control unit 20 is mounted in the embodiment described above, a computer program that causes a computer to serve as the recording apparatus 40 in the embodiment described above, and a non-transitory tangible recording medium in which the computer program is recorded.

What is claimed is:

1. A recording method of a flag, the recording method being executed by a computer, the flag being configured to be used in determination of a replacement history of an electronic control unit configured to be mounted on a vehicle, the recording method comprising:
detecting, by the computer, an operation executed by the electronic control unit at a time of factory shipment of the vehicle; and
recording, by the computer, an unreplaced flag indicating that the electronic control unit is not replaced in a memory when the operation is detected, the electronic control unit comprising the memory.

2. The recording method according to claim 1, wherein a replaced flag indicating that the electronic control unit is replaced is recorded in advance in a storage region that is not rewritable except when the operation is detected, the storage region being within the memory.

3. The recording method according to claim 2, further comprising rewriting the replaced flag to the unreplaced flag and recording the unreplaced flag in the memory by the computer when the operation is detected.

4. A recording apparatus of a flag, the flag being configured to be used in determination of a replacement history of an electronic control unit configured to be mounted on a vehicle, the recording apparatus comprising:
one or more processors; and
one or more memories communicably coupled to the one or more processors, wherein the one or more processors are configured to:
detect an operation executed by the electronic control unit at a time of factory shipment of the vehicle; and
record an unreplaced flag indicating that the electronic control unit is not replaced in a memory when the operation is detected, the electronic control unit comprising the memory.

5. An electronic control unit configured to be mounted on a vehicle, the electronic control unit comprising a memory, wherein:
either a replaced flag indicating that the electronic control unit is replaced or an unreplaced flag indicating that the electronic control unit is not replaced is recorded in the memory; and
the replaced flag is configured to be rewritten to the unreplaced flag by being triggered by an operation executed by the electronic control unit at a time of factory shipment of the vehicle.
